(19) United States
(12) Patent Application Publication
(10) Pub. No.: US 2014/0191536 A1
(43) Pub. Date: Jul. 10, 2014

(54) METHOD, VEHICLE REINFORCEMENT & VEHICLE

(71) Applicant: VOLVO CAR CORPORATION, Gothenburg (SE)

(72) Inventors: Jens Elfwing, Torslanda (SE); Michael Wehrend, Gothenburg (SE); Johan Nedemo, Ahus (SE); Kristoffer Trana, Kristianstad (SE)

(73) Assignee: VOLVO CAR CORPORATION, Gothenburg (SE)

(21) Appl. No.: 14/152,390

(22) Filed: Jan. 10, 2014

(30) Foreign Application Priority Data
Jan. 10, 2013 (EP) 13150868.1

(51) Int. Cl. C21D 9/00; B62D 29/00; B62D 65/02

(52) U.S. Cl. CPC C21D 9/0068; B62D 65/02; B62D 29/007
USPC 296/193.06; 148/529; 296/193.01; 296/203.03; 296/209

(57) ABSTRACT

A method of manufacturing a vehicle reinforcement includes the step of a) joining a first portion comprising boron steel to a second portion comprising more ductile material than boron steel to form a vehicle reinforcement, and b) heat treating at least one part of the first portion after the joining so that the vehicle reinforcement comprises at least one hardened zone of boron steel and at least one soft zone of more ductile material than boron steel.

### CROSS-REFERENCE TO RELATED APPLICATIONS

This application claims foreign priority benefits under 35 U.S.C. §119(a)-(d) to European patent application number EP 13150868.1, filed Jan. 10, 2013, which is incorporated by reference in its entirety.

### TECHNICAL FIELD

The present disclosure concerns a method for manufacturing a vehicle reinforcement and a vehicle reinforcement manufactured using such a method. The present disclosure also concerns a vehicle comprising at least one such vehicle reinforcement or vehicle pillar.

### BACKGROUND

By law, all new car models must pass certain safety tests and certifying procedures in different countries or regions, such as side impact tests, for example pole side impact tests, before they are sold.

Several side impact structures for vehicles having improved side impact crash behavior have been disclosed in the prior art. For example, U.S. Pat. No. 6,524,404 discloses a B-pillar reinforcement, i.e., a pillar reinforcement that supports the roof of a vehicle and that is located between the front and rear side windows, having improved crash behavior and which constitutes a longitudinal steel profile. The longitudinal profile has an upper part comprised of a martensitic material structure and a strength of more than 1400 N/mm² and has a lower part of higher ductility (or so called “soft zone”) with a predominantly ferritic-perlitic material structure and a strength of below 850 N/mm².

The B-pillar reinforcement is manufactured in a warm form process, starting with a form blank or a pre-formed longitudinal profile which is subjected to a heat treatment in a furnace yielding an austenitic material structure and, subsequently, it is re-formed/hardened to a martensitic material structure in a cooled tool or equipment. Large areas of the blank or, respectively, the pre-formed longitudinal profile can be isolated or protected in the furnace against temperature effects. Thus, these areas are not subjected to a significant heating, such that the temperature increase overall in these areas is markedly below the temperature causing an austenitic material structure. It follows that there can be achieved, in the cooled tool or equipment, an absence of martensitic material structure with high strength in the areas not subjected to significant heating.

### SUMMARY

An object of the disclosure is to provide an improved method for manufacturing a vehicle-reinforcement.

This object is achieved by a method comprising the steps of a) joining a first portion comprising boron steel to a second portion comprising more ductile material than boron steel to form a vehicle reinforcement, and then b) heat treating at least one part of the first portion after the joining so that the vehicle reinforcement comprises at least one hardened zone of boron steel (i.e., the at least one heat treated part of the first portion) and at least one soft zone of more ductile material than boron steel (i.e., the second portion and any non-heat treated part(s) of the first portion). The first portion comprises (or is made of) boron steel which responds to heat treatment in order to create a martensitic structure after the heat treatment. The second portion comprises (or is made of) a material that does not respond to the heat treatment like boron steel but remains ductile.

Since boron steel is used in only the first part of the vehicle reinforcement, substantial reductions in material costs may be made using such a manufacturing method. Furthermore, since the soft zone, i.e., a zone comprising material that is more deformable and ductile than the boron steel to which it is joined, is located next to a joint, such as a weld joint, this will reduce or eliminate the risk of the vehicle reinforcement cracking in and/or around the joint in the event of a collision, resulting in improved crash behaviour. In the event of a side impact collision, the side impact structure according to the present disclosure will not crack, or it will be substantially less likely to crack in the region(s) of the at least one soft zone due to the increased ductility in said region(s) and will therefore improve the vehicle's ability to survive the side impact without suffering passenger compartment intrusion. A vehicle reinforcement, such as a vehicle pillar with such at least one soft zone located at the lower part thereof will furthermore improve the vehicle's ability to prevent passenger compartment intrusion in the event of a collision.

Additionally, a first portion comprising boron steel is stiffer and more lightweight than a component comprising normal steel on account of the alloys that have been added during manufacture, thereby making a vehicle comprising a vehicle reinforcement according to an embodiment of the present disclosure safer, lighter and more fuel-efficient than a vehicle having at least one vehicle reinforcement made of normal steel.

According to an embodiment of the disclosure, the vehicle reinforcement constitutes one of: a vehicle pillar reinforcement, such as an A-, a B- or C-pillar reinforcement, a roof rail, a sill member.

According to another embodiment of the disclosure, the first portion is an upper part of a vehicle pillar reinforcement and the second portion is a lower part of a vehicle pillar reinforcement when the vehicle pillar has been mounted in the vehicle.

According to another embodiment of the disclosure, the at least one hardened zone is arranged to be located substantially in the upper half, the upper third or upper quarter of the vehicle pillar when it is mounted in a vehicle.

According to a further embodiment of the disclosure, the first portion and/or the second portion comprises a tailor roller blank (TRB). A tailored rolled blank (TRB) (or “tailored blank”) is a metal sheet, which is typically composed of various steel grades and thicknesses. This allows different parts of a vehicle reinforcement manufactured from the TRB to be adapted to local loads, which would otherwise require additional strengthening components. Benefits of using TRBs therefore include reducing component weight and manufacturing costs. Typically individual sheet metal plates are welded together by laser welding to produce a TRB.

According to an embodiment of the disclosure, the second portion comprises a tailor welded blank (TWB). A tailor welded blank is a single component typically composed of various steel grades and thicknesses, joined at a factory usually by a laser weld.

According to another embodiment of the disclosure the first portion has a non-uniform thickness.

The present disclosure also concerns a vehicle reinforcement manufactured using a method according to an embodiment of the disclosure. The vehicle reinforcement has a first portion and a second portion. The first portion comprises boron steel, and the second portion comprises more ductile material than boron steel. The first portion and the second portion are joined together, by a weld joint for example, whereby at least one part of the first portion has been heat treated after it has been joined to the second portion so that it comprises at least one hardened zone of boron steel and at least one soft zone of more ductile material than boron steel.

According to an embodiment of the disclosure, the vehicle reinforcement constitutes one of: a vehicle pillar reinforcement, such as an A-, a B- or C-pillar reinforcement, a roof rail, or a sill member.

According to another embodiment of the disclosure, the first portion is an upper part of a vehicle pillar and the second portion is a lower part of a vehicle pillar.

According to a further embodiment of the disclosure, the first portion and/or the second portion comprises a tailor roller blank (TRB).

According to an embodiment of the disclosure, the second portion comprises a tailor welded blank (TWB).

According to another embodiment of the disclosure, the first portion has a non-uniform thickness.

The present disclosure also concerns a vehicle comprising at least one vehicle reinforcement according to any of the embodiments of the disclosure.

### BRIEF DESCRIPTION OF THE DRAWINGS

Non-limiting examples according to the present disclosure will hereinafter be further explained with reference to the attached drawings.

FIG. 1 shows a vehicle according to an embodiment of the disclosure;

FIG. 2 shows a vehicle body comprising at least one vehicle reinforcement according to an embodiment of the disclosure;

FIG. 3 shows a vehicle reinforcement blank before heat treatment;

FIG. 4 shows a finished vehicle reinforcement according to an embodiment of the disclosure; and

FIG. 5 is a flow diagram showing the steps of a method according to an embodiment of the disclosure.

It should be noted that the drawings have not been drawn to scale and that the dimensions of certain features have been exaggerated for the sake of clarity.

### DETAILED DESCRIPTION

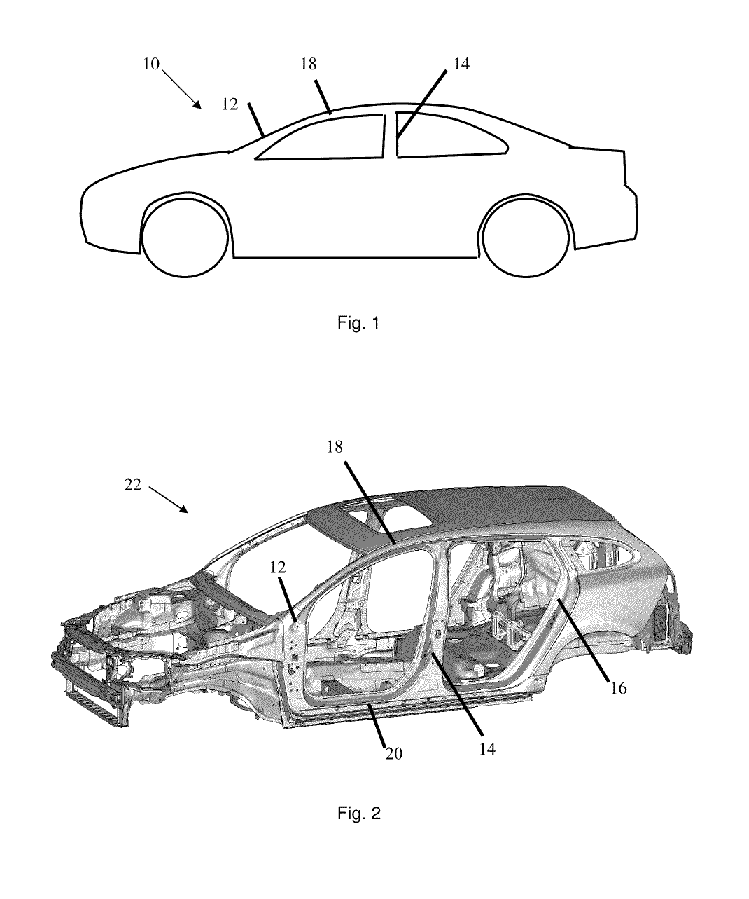

FIGS. 1 and 2 show a vehicle 10 and vehicle body 22 comprising at least one vehicle reinforcement 12, 14, 16, 18, 20 according to an embodiment of the invention. The vehicle reinforcement can be a vehicle pillar reinforcement such as an A-pillar reinforcement 12, a B-pillar reinforcement 14 or a C-pillar reinforcement 16 etc., a roof rail 18 or a sill member 20.

An A-pillar reinforcement 12 is a structural support on a side of a vehicle's windscreen located just ahead of and above the vehicle's front doors, i.e., a structural component that extends between a sill member 20 and a roof member 18 of the vehicle. An “A-pillar” reinforcement according to the present disclosure may extend up to the point where the A-pillar reinforcement 12 meets the B-pillar reinforcement 14, or it may include a structural component that forms a continuation of the A-pillar reinforcement 12 that extends above the doors of the vehicle 10 along the roof of the vehicle beyond the B-pillar reinforcement 14. The A-pillar reinforcement 12 and C-pillar reinforcement 16 according to an embodiment of the disclosure together may form the roof rail 18 of a vehicle 10. Alternatively, a roof rail 18 may be provided between vehicle pillar reinforcements (between the A-pillar reinforcement 12 and the B-pillar reinforcement 14 and/or between the B-pillar reinforcement 14 and the C-pillar reinforcement, etc.).

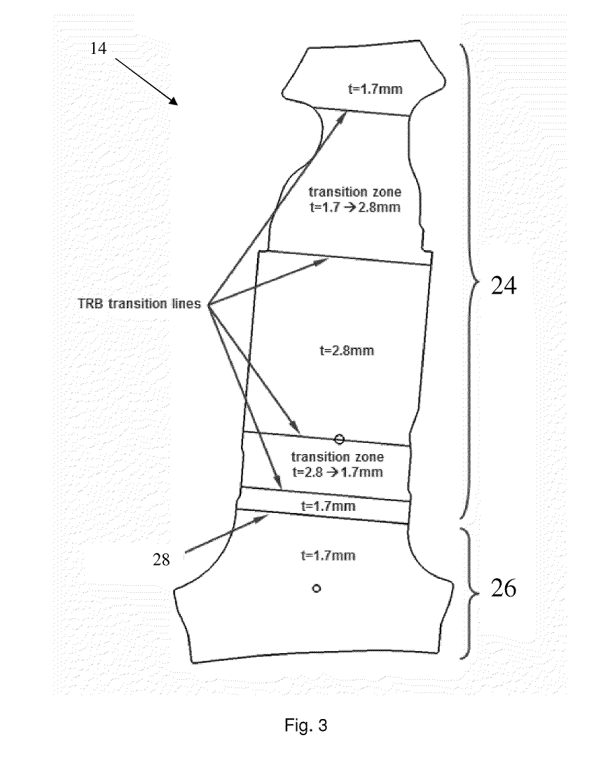

FIG. 3 shows a vehicle reinforcement blank, namely a B-pillar reinforcement blank 14, prior to being subjected to a heat treatment, such as hot forming. The B-pillar reinforcement blank 14 is manufactured by a) joining a first (upper) portion 24 comprising boron steel, which constitutes the upper part of the B-pillar reinforcement 14, to a second (lower) portion 26 comprising more ductile material than boron steel, which constitutes the lower part of the B-pillar reinforcement 14.

The B-pillar reinforcement blank 14 illustrated in FIG. 3 comprises a joint 28, namely a weld seam, between the first portion 24 and the second portion 26. TRB transition lines between a plurality of zones of the first portion 24 having different thicknesses t are also shown in FIG. 3. In the illustrated embodiment the second portion 26 has a uniform thickness between 1.0-2.0 mm, such as 1.7 mm. The B-pillar reinforcement blank 14 may be arranged to have a uniform thickness in the vicinity of the weld seam 28, i.e., within 50 mm of a joint. The first portion 24 may have a non-uniform thickness in a zone above this region of uniform thickness (for example a transition zone having a variable thickness of 1.7-2.8 mm). The first portion 24 and the second portion 26 may however comprises portions of any suitable uniform or non-uniform thickness.

At least one part of the B-pillar reinforcement blank 14 shown in FIG. 3 may be b) heat treated after the joining of its constituent portions 24, 26 so that the finished B-pillar reinforcement 14 comprises at least one hardened zone of boron steel in the upper part 24 thereof and at least one soft zone of more ductile material than boron steel in the lower part 26 thereof.

Any known manufacturing method, such as hot forming, may be used to produce a vehicle reinforcement 12, 14, 16, 18, 20 according to the present disclosure. In hot forming, a vehicle reinforcement 12, 14, 16, 18, 20 may be heated to austenitization temperature in a furnace and thereafter formed to the desired shape in a tool using a press for example. The tool may be cooled, by water for example, and when the press has finished its stroke (i.e., the forming) the press force may be increased so that the cooling (quenching) of the formed part quickly results in the formation of the desired martensitic structure in the vehicle reinforcement 12, 14, 16, 18, 20. The vehicle reinforcement contour and holes may be finish-trimmed thereafter, using a laser cutting process for example.

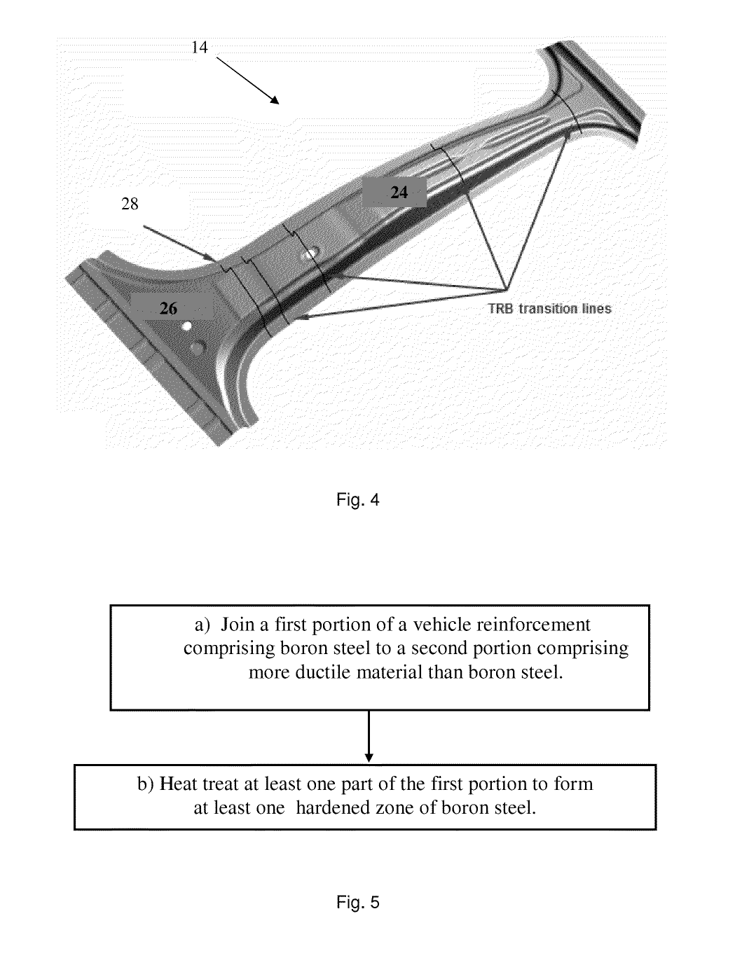

FIG. 4 shows a finished B-pillar reinforcement 14 according to an embodiment of the present disclosure. A vehicle reinforcement according to the present invention will exhibit a joint, such as a weld seam, which may be visible, between a first portion 24 and a second portion 26 thereof. The first portion 24 and/or the second portion 26 may be of variable thickness. A hardness test, such as a Vicker's Hardness Test, and/or metallurgical structure analysis may be used to determine that the first portion 24 comprises boron steel having a hardened zone comprising martensitic material, and that the second portion 26 comprises at least one soft zone of more ductile material than boron steel.

According to an embodiment of the disclosure, the material constituting the soft zone has a tensile strength of 800 MPA or lower or a Vicker's Hardness value of 350HV30 or less.

According to another embodiment of the disclosure, the boron steel constituting at least one hardened zone comprises martensitic material, having a tensile strength of 1300 MPa or more.

According to an embodiment of the disclosure, the at least one hardened zone is arranged to be located substantially in the upper half, the upper third or upper quarter of the vehicle pillar reinforcement 12, 14, 16 when it is mounted in a vehicle 10.

The first (upper) portion 24 may comprise a tailor roller blank (TRB) of non-uniform thickness and the second (lower) portion 26 may comprise a tailor welded blank (TWB).

The first portion 24 and/or the second portion 26 may have a uniform or non-uniform thickness varying between 0.8 to 2.5 mm for example, more preferably 1-1.5 mm.

It should be noted that a vehicle reinforcement 12, 14, 16, 18, 20 according to an embodiment of the present invention may comprise at least one additional portion comprising boron steel other than the first portion 24, which may be joined to the first and/or second portion 26 and then heat treated to form at least one hardened zone. The vehicle reinforcement 12, 14, 16, 18, 20 according to an embodiment of the present disclosure may also comprise at least one additional portion comprising more ductile material than boron steel which may be joined to the first portion 24 and/or second portion 26 to form at least one soft zone of more ductile material than boron steel.

FIG. 5 shows a flow diagram showing the steps of a method according to the present disclosure. The method includes the steps of a) joining a first portion 24 comprising boron steel to a second portion 26 comprising more ductile material than boron steel to form a vehicle reinforcement 12, 14, 16, 18, 20, and then b) heat treating at least one part of the first portion 24 after the joining so that the vehicle reinforcement 12, 14, 16, 18, 20 comprises at least one hardened zone of boron steel (in the first portion 24 thereof) and at least one soft zone of more ductile material than boron steel (in the second portion 26 thereof and any non-heat treated part(s) of the first portion 24). A vehicle pillar reinforcement 12, 14, 16 manufactured using such a method may then be mounted in a vehicle with the at least one hardened zone of boron steel located in the upper half thereof.

It should be noted that a vehicle reinforcement 12, 14, 16, 18, 20 according to an embodiment of the present disclosure may be arranged to comprise at least one additional soft zone that solely promotes desired deformation behavior of the vehicle reinforcement 12, 14, 16, 18, 20 in the event of a collision, which additional soft zone may for example be located in portions of the vehicle reinforcement 12, 14, 16, 18, 20 other than in the second portion 26, such as in the first portion 24 or in an additional portion thereof.

The first portion 24 and the second portion 26 may be joined by welding, such as by resistance spot welding, laser welding, arc welding or any other suitable joining method, such as adhesion.

Further modifications of the disclosure within the scope of the claims would be apparent to a skilled person.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of manufacturing a vehicle reinforcement, the method comprising:
joining a first portion comprising boron steel to a second portion comprising more ductile material than boron steel to form a vehicle reinforcement; and
heat treating at least one part of the first portion after the joining so that the vehicle reinforcement comprises at least one hardened zone of boron steel and at least one soft zone of more ductile material than boron steel.

2. The method according to claim 1 wherein the vehicle reinforcement comprises one of: a vehicle pillar reinforcement, a roof rail, a sill member.

3. The method according to claim 1 wherein the first portion is an upper part of a vehicle pillar reinforcement, and the second portion is a lower part of the vehicle pillar reinforcement.

4. The method according to claim 1 wherein the vehicle reinforcement comprises a vehicle pillar reinforcement, and wherein the at least one hardened zone is arranged to be located substantially in an upper half, upper third or upper quarter of the vehicle pillar reinforcement when the vehicle pillar reinforcement is mounted in a vehicle.

5. The method according to claim 1 wherein the first portion and/or the second portion comprise/comprises a tailor roller blank.

6. The method according to claim 1 wherein the second portion comprises a tailor welded blank.

7. The method according to claim 1 wherein the joining comprises joining the first portion to the second portion by welding.

8. The method according to claim 1 wherein the first portion has a non-uniform thickness.

9. A vehicle reinforcement comprising:
a first portion that comprises boron steel; and
a second portion that comprises more ductile material than boron steel;
wherein the first portion and the second portion are connected by a joint, and wherein at least one part of the first portion has been heat treated after the first portion has been joined to the second portion so that the vehicle reinforcement comprises at least one hardened zone of boron steel and at least one soft zone of more ductile material than boron steel.

10. The vehicle reinforcement according to claim 9 wherein the vehicle reinforcement comprises one of: a vehicle pillar reinforcement, a roof rail, a sill member.

11. The vehicle reinforcement according to claim 9 wherein the first portion is an upper part of a vehicle pillar reinforcement, and the second portion is a lower part of the vehicle pillar reinforcement.

12. The vehicle reinforcement according to claim 11 wherein the at least one hardened zone is arranged to be located substantially in an upper half, upper third or upper quarter of the vehicle pillar reinforcement when the vehicle pillar reinforcement is mounted in a vehicle.

13. The vehicle reinforcement according to claim 9 wherein the first portion and/or the second portion comprise/comprises a tailor roller blank.

14. The vehicle reinforcement according to claim 9 wherein the second portion comprises a tailor welded blank.

15. The vehicle reinforcement according to claim 9 wherein the first portion is welded to the second portion.

16. The vehicle reinforcement according to claim 9 wherein the first portion has a non-uniform thickness.

17. A vehicle comprising at least one vehicle reinforcement according to claim 9.
